(19) United States
(12) Patent Application Publication
(10) Pub. No.: US 2026/0141515 A1
(43) Pub. Date: May 21, 2026

(54) AUTOMATIC SELECTION METHOD AND SYSTEM FOR ENDOSCOPIC IMAGES

(71) Applicants: INVENTEC (PUDONG) TECHNOLOGY CORPORATION, Shanghai (CN); INVENTEC CORPORATION, Taipei City (TW)

(72) Inventors: Chun-Ti CHOU, Taipei City (TW); Wei-Chao CHEN, Taipei City (TW); Chih-Pin WEI, Taipei City (TW); Po Hsuan HUANG, Taipei City (TW); Jen-Po CHENG, Taipei City (TW); Chiu-Jung LU, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/234,746

(22) Filed: Jun. 11, 2025

(30) Foreign Application Priority Data
Nov. 20, 2024 (CN) 202411669354.5

(51) Int. Cl. G06T 7/00; G06T 7/10; G06T 7/90

(52) U.S. Cl. CPC G06T 7/0012; G06T 7/10; G06T 7/90; G06T 2207/10068; G06T 2207/20081; G06T 2207/30204

(57) ABSTRACT

An automatic selection method and system for endoscopic images are proposed. This method includes several steps performed by a computing device, which involve: obtaining multiple endoscopic images and their corresponding position markers, with each marker indicating a specific part of a human organ captured by the endoscope. Based on these position markers, multiple candidate images belonging to the same organ part are selected from the endoscopic images. An image segmentation is performed based on an image color or a predefined symptom to divide each candidate image into a first and a second non-overlapping region. A ratio is calculated based on the areas of the first and second regions, and at least one candidate image with a ratio greater than a threshold is outputted as the selection result.

### CROSS-REFERENCE TO RELATED APPLICATIONS

This non-provisional application claims priority under 35 U.S.C. § 119(a) on Patent Application No(s). 202411669354.5 filed in People Republic of China on Nov. 20, 2024, the entire contents of which are hereby incorporated by reference.

### BACKGROUND

### 1. Technical Field

This disclosure relates to endoscopic images, and more particularly, to an automatic selection method and system for endoscopic images.

### 2. Related Art

Endoscopic examination is an important medical procedure, primarily used to observe the condition of the human digestive tract for purposes such as disease diagnosis, treatment, and screening. Through the endoscopic examination, a physician may inspect the health situation of the internal of digestive tract, and looking for signs of ulcers, tumors, or other lesions. During the examination process, the physician captures and archives images of any abnormal situations to document the examination result, and facilitating for subsequent diagnosis and treatment planning. A physician typically examines different regions of a digestive organ, such as the greater curvature and lesser curvature of the stomach, or the anterior and posterior sections of the intestine, and retains multiple images of each region for reference.

However, since the examination habit and the judgment way of each physician are different, endoscopic images are not consistent in terms of shooting angle, target distance, and photographic standards, and this results in significant discrepancies in the image data retained from each examination. When a new image analysis technology is applied to endoscopic images, these inconsistencies make the application more difficult. Furthermore, the number of images of different parts is also inconsistent. When conducting an overall disease risk assessment, it is not possible to determine which image should be used as the basis for analysis, and the decision need to be made by the physician. This situation may cause selection preference of each physician to affect the assessment result, thereby reducing the stability and reliability of the assessment.

### SUMMARY

Accordingly, this disclosure provides an automatic selection method and system for endoscopic images to improve the selection speed of endoscopic images and solve the problem of inconsistent selection standard.

According to an embodiment of this disclosure, an automatic selection method for endoscopic images comprises a plurality of steps performed by a computing device, and these steps comprises: obtaining a plurality of endoscopic images and a plurality of position markers corresponding to the plurality of endoscopic images, wherein each position marker is configured to indicate a specific part of a human organ captured by an endoscope, selecting a plurality of candidate images belonging to the same specific part from the plurality of endoscopic images based on the plurality of position markers, performing an image segmentation based on an image color or a predefined symptom to divide each of the plurality of candidate images into a first region and a second region non-overlapping with each other, calculating a ratio based on an area of the first region and an area of the second region, and outputting at least one of the plurality of candidate images with the ratio greater than a threshold as a selection result.

According to an embodiment of this disclosure, an automatic selection system for endoscopic images comprises a storage device and a computing device. The storage device is configured to store a plurality of endoscopic images and a plurality of position markers corresponding to the plurality of endoscopic images, wherein each position marker is configured to indicate a specific part of a human organ captured by an endoscope. The computing device is electrically connected to the storage device. The computing device is configured to select a plurality of candidate images belonging to the same specific part from the plurality of endoscopic images based on the plurality of position markers, perform an image segmentation based on an image color or a predefined symptom to divide each of the plurality of candidate images into a first region and a second region non-overlapping with each other, calculate a ratio based on an area of the first region and an area of the second region, and output at least one of the plurality of candidate images with the ratio greater than a threshold as a selection result.

In view of the above description, the automatic selection method and system for endoscopic images proposed by the present disclosure have the following advantages: standardizing the selection process of endoscopic images, because there is no need for manual selection of endoscopic images, and enhancing the efficiency of model development and application based on endoscopic images, enabling rapid adaption to different evaluation objectives, such as calculating Corpus-predominant Gastritis Index (CGI) with endoscopic images or calculating Gastric Intestinal Metaplasia (GIM) index with endoscopic images.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an automatic selection system for endoscopic images according to an embodiment of the present disclosure; and

FIG. 2 is a flowchart of an automatic selection method for endoscopic images according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

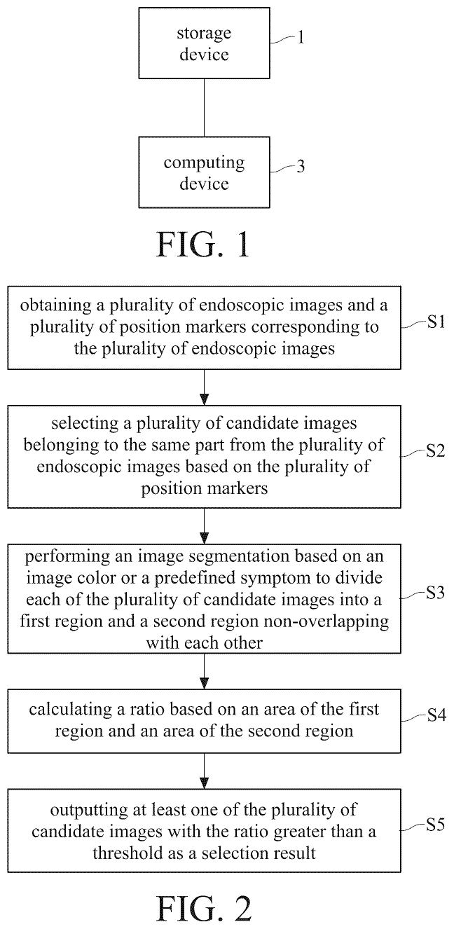

FIG. 1 is a block diagram of an automatic selection system for endoscopic images according to an embodiment of the present disclosure. As shown in FIG. 1, this system includes a storage device 1 and a computing device 3.

The storage device 1 is configured to store a plurality of endoscopic images and a plurality of position markers corresponding to the plurality of endoscopic images. Each position marker is configured to indicate a specific part of a human organ captured by the endoscope, such as the greater curvature and lesser curvature of the stomach, or the upper section and lower section of the intestine. In an embodiment, these endoscopic images are tissue hemoglobin index (Index of Hemoglobin, IHb) images captured using a narrow-band imaging light source. In another embodiment, these endoscopic images are general endoscopic images using white light. The present disclosure does not limit the type of light source used for capturing the endoscopic images. Furthermore, when capturing different parts of the same human organ, an overlapping region may be included between the plurality of generated endoscopic images. Therefore, the same one endoscopic image may have multiple position markers at the same time. The present disclosure does not restrict the initial source of the position marker, the position marker may be manually assigned or automatically generated using existing image recognition algorithm and model.

The storage device 1 may be a hard drive, a memory in a computer, or an external storage apparatus connected to a computer. In an embodiment, the storage device 1 may be implemented using at least one of the following examples: a flash memory, a hard disk drive (HDD), a solid state disk (SSD), a dynamic random-access memory (DRAM), a static random-access memory (SRAM), or other non-volatile memory. However, the disclosure is not limited to the above examples.

As shown in FIG. 1, the computing device 3 is electrically connected to the storage device 1. The computing device 3 is configured to select a plurality of candidate images belonging to the same specific part from the plurality of endoscopic images based on the plurality of position markers, perform an image segmentation based on an image color or a predefined symptom to divide each of the plurality of candidate images into a first region and a second region non-overlapping with each other, calculate a ratio based on an area of the first region and an area of the second region, and output at least one of the plurality of candidate images with the ratio greater than a threshold as a selection result.

In an embodiment, the computing device 3 may use at least one of the following examples: a personal computer, a network server, a central processing unit (CPU), a graphics processing unit (GPU), a microcontroller unit (MCU), an application processor (AP), a field-programmable gate array (FPGA), an application-specific integrated circuit (ASIC), system-on-a-chip (SoC), a deep learning accelerator, or any other electronic device with similar functionality. The present disclosure does not limit the hardware type of the computing device 3.

FIG. 2 is a flowchart of an automatic selection method for endoscopic images according to an embodiment of the present disclosure, including steps S1 to S5 performed by the computing device 3.

In step S1, the computing device 3 obtains a plurality of endoscopic images and a plurality of position markers corresponding to the plurality of endoscopic images, wherein each of the position markers is configured to indicate a specific part of a human organ captured by an endoscope.

In step S2, the computing device 3 selects a plurality of candidate images belonging to the same specific part from the plurality of endoscopic images based on the plurality of position markers.

In step S3, the computing device 3 performs an image segmentation based on an image color or a predefined symptom to divide each candidate image into a first region and a second region non-overlapping with each other. The number of regions may be adjusted according to the practical application, and the present disclosure is not limited thereto.

A first embodiment of image segmentation is to perform segmentation based on image color: first, an IHb image that may show the distribution of red blood cells is captured using a narrow band imaging (NBI) light source. In IHb images, usually red indicates regions with a higher number of red blood cells (healthy part), and green or blue indicates regions with a lower number of red blood cells (parts with inflammation or other symptoms). Therefore, this embodiment uses different color blocks in the IHb image as the basis for image segmentation. First, the color space is converted, then a threshold is set for each dimension of the color space, and then screening is performed based on the magnitude of the threshold. For example, the image is first converted from the RGB space to the HSV space, and then the threshold range of each dimension is set for hue (H), saturation (S) and value (V) to screen out the region that meets the range as one of the segmentation results. Resetting the threshold and repeating this step may be used to obtain the second area. In other words, performing image segmentation involves identifying the first region and the second region based on different colors in the IHb image.

A second embodiment of image segmentation is to perform segmentation based on image color: first, multiple endoscopic images are obtained by capturing the images with white light, and then the computing device 3 executes an image processing algorithm to convert a type of these images into IHb images. In this embodiment, multi-spectral analysis or machine learning technology may be used to estimate the hemoglobin concentration in the tissue to generate an image effect similar to IHb. In this way, even without a dedicated light source, hemoglobin information may also be extracted from the original image to generate an IHb image. The method of image segmentation is the same as that of the first embodiment, that is, the first region and the second region are distinguished based on the different colors in the IHb image.

A third embodiment of image segmentation is to perform segmentation based on a preset symptom: It is known that a deep image segmentation model may be applied to endoscopic images (Nien, Chu-Min, et al. “Criss-cross attention based multi-level fusion network for gastric intestinal metaplasia segmentation.” MICCAI Workshop on Imaging Systems for GI Endoscopy. Cham: Springer Nature Switzerland, 2022). Through different data annotations, the model may be trained to divide endoscopic images according to different symptoms. Therefore, in the embodiment, the computing device 3 trains a deep learning model to identify a symptom site from each of endoscopic images. Performing image segmentation includes: for each of the candidate images, distinguishing the first region and the second region based on the symptom site and the part that does not belong to the symptom site.

In step S4, the computing device 3 calculates a ratio based on an area of the first region and an area of the second region. In an embodiment, the computing device 3 uses the number of pixels in the region as the area of the region. Regarding the ratio calculation, for example, assuming that the area of the healthy region is A and the area of the inflamed region is B, the computing device 3 may calculate A/B or B/A as the ratio. Assuming that the number of the segmented region types are greater than two, such as A, B, and C, the computing device 3 may calculate, for example, A/(B+C) or (A+C)/B as the ratio.

In step S5, the computing device 3 outputs at least one candidate image with the ratio greater than a threshold as a selection result. The setting of the threshold may be the maximum, minimum, average of all the ratios calculated in step S4, or a preset value. The phrase “greater than . . . ” in step S5 may also be adapted to “less than . . . ” or “between . . . ” depending on the application example. In addition, the present disclosure does not limit the number of images included in the selection result. The number of images may be more than one image.

In FIG. 2, process of steps S3 to S5 shows how to deal with the plurality of candidate images of the same human organ part. In practical applications, this process may be performed simultaneously or sequentially on endoscopic images from different organ parts, thereby selecting representative images for each organ part.

Two practical application examples of the present disclosure are as follows:

Example 1: Calculating of Corpus-predominant Gastritis Index (CGI): This index uses gastric endoscopic images of different parts to assess whether a patient belongs to a high-risk group for gastric cancer. Currently, the physician manually selects images for assessment, while the present disclosure may automatically select the image using a specific color ratio in IHb image to avoid human bias and improve efficiency.

Example 2: Calculation of Gastric Intestinal Metaplasia (GIM): This index uses gastric NBI images of different parts as input to assess the severity of overall gastric mucosal intestinal metaplasia, thereby serving as an assessment standard for high-risk groups for gastric cancer. The present disclosure may assign a score to each image based on the gastric intestinal metaplasia area ratio, and select the image with the highest area ratio as the final evaluation image, so that a physician may evaluate the most severe situation and make appropriate treatment.

In view of the above description, the automatic selection method and system for endoscopic images proposed by the present disclosure have the following advantages: standardizing the selection process of endoscopic images, because there is no need for manual selection of endoscopic images, and enhancing the efficiency of model development and application based on endoscopic images, enabling rapid adaption to different evaluation objectives, such as calculating CGI with endoscopic images or calculating GIM with endoscopic images.

What is claimed is:

1. An automatic selection method for endoscopic images, comprising a plurality of steps performed by a computing device, and the plurality of steps comprising:
obtaining a plurality of endoscopic images and a plurality of position markers corresponding to the plurality of endoscopic images, wherein each of the plurality of position markers is configured to indicate a specific part of a human organ captured by an endoscope;
selecting a plurality of candidate images belonging to the same specific part from the plurality of endoscopic images based on the plurality of position markers;
performing an image segmentation based on an image color or a predefined symptom to divide each of the plurality of candidate images into a first region and a second region non-overlapping with each other;
calculating a ratio based on an area of the first region and an area of the second region; and
outputting at least one of the plurality of candidate images with the ratio greater than a threshold as a selection result.

2. The automatic selection method for endoscopic images according to claim 1, further comprising:
capturing the plurality of endoscopic images using a narrow-band imaging light source, wherein the plurality of endoscopic images are tissue hemoglobin index images;
wherein performing the image segmentation based on the image color or the predefined symptom comprising: distinguishing the first region and the second region based on different colors in each of the tissue hemoglobin index images.

3. The automatic selection method for endoscopic images according to claim 1, further comprising:
capturing the plurality of endoscopic images using white light; and
executing an image processing algorithm to convert a type of the plurality of endoscopic images into tissue hemoglobin index images;
wherein performing the image segmentation based on the image color or the predefined symptom comprising: distinguishing the first region and the second region based on different colors in each of the tissue hemoglobin index images.

4. The automatic selection method for endoscopic images according to claim 1, further comprising:
training a deep learning model to identify a symptom site from each of the plurality of endoscopic images;
wherein performing the image segmentation based on the image color or the predefined symptom comprising: for each of the plurality of candidate images, distinguishing the first region and the second region based on the symptom site and a part not belonging to the symptom site.

5. An automatic selection system for endoscopic images, comprising:
a storage device configured to store a plurality of endoscopic images and a plurality of position markers corresponding to the plurality of endoscopic images, wherein each of the plurality of position markers is configured to indicate a specific part of a human organ captured by an endoscope; and
a computing device electrically connected to the storage device, and configured to select a plurality of candidate images belonging to the same specific part from the plurality of endoscopic images based on the plurality of position markers, perform an image segmentation based on an image color or a predefined symptom to divide each of the plurality of candidate images into a first region and a second region non-overlapping with each other, calculate a ratio based on an area of the first region and an area of the second region, and output at least one of the plurality of candidate images with the ratio greater than a threshold as a selection result.

6. The automatic selection system for endoscopic images according to claim 5, wherein the plurality of endoscopic images are tissue hemoglobin index images captured using a narrow-band imaging light source, and the computing device performing the image segmentation based on the image color or the predefined symptom is based on different colors in each of the tissue hemoglobin index images to distinguish the first region and the second region.

7. The automatic selection system for endoscopic images according to claim 5, wherein the plurality of endoscopic images is captured using white light, the computing device is further configured to execute an image processing algorithm to convert a type of the plurality of endoscopic images into tissue hemoglobin index images, and the computing device performing the image segmentation based on the image color or the predefined symptom is based on different colors in each of the tissue hemoglobin index images to distinguish the first region and the second region.

8. The automatic selection system for endoscopic images according to claim 5, wherein the storage device is further configured to store a deep learning model, the computing device is further configured to run the deep learning model to identify a symptom site from each of the plurality of endoscopic images, and the computing device performing the image segmentation based on the image color or the predefined symptom is to distinguish the first region and the second region based on the symptom site and a part not belonging to the symptom site for each of the plurality of candidate images.
